(19) United States
(12) Patent Application Publication
(10) Pub. No.: US 2007/0279520 A1
(43) Pub. Date: Dec. 6, 2007

(54) IMAGE SENSING DEVICE AND PACKAGE METHOD THEREFOR

(75) Inventors: Hsiao-Wen Lee, Hsinchu (TW); Chih-Kung Chang, Hsinchu County (TW); Pai-Chun Peter Zung, Hsinchu (TW); Chien-Pang Lin, Hsinchu County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: VISERA TECHNOLOGIES COMPANY, LTD., Hsinchu (TW)

(21) Appl. No.: 11/676,813

(22) Filed: Feb. 20, 2007

(30) Foreign Application Priority Data
Jun. 2, 2006 (TW) 095119768

(51) Int. Cl. H04N 5/238

(52) U.S. Cl. 348/374; 348/E05.034

(57) ABSTRACT

A package module for an image sensing device is provided. The package module includes a substrate having thereon a photoelectric element array, a first optical element array formed on the photoelectric element array, a package lid having thereon a second optical element array opposite to the first optical element array and having an arrangement corresponding to that of the first optical element array; and a spacer disposed on a bonding area between the package lid and the substrate for adjusting a distance between the package lid and the substrate.

### FIELD OF THE INVENTION

The present invention refers to an image sensing device, in particular to a package structure and a package method of the image sensing device.

### BACKGROUND OF THE INVENTION

As the applications of the optoelectonic device become more and more popular, the demands for the image sensing device increase rapidly In general, typical image sensors can be categorized into two main parts, which are the charge coupled device (CCD) image sensors and the complementary metal-oxide semiconductor (CMOS) image sensors. Nevertheless, no matter they are CCD or CMOS image sensors, both of them are the photoelectric elements, which are made of the semiconductor elements and used for sensing the photo energy and converting such photo energy into the electronic signals. After generating the electronic signals, at least one analog to digital (A/D) converter is used for converting the electronic signals into the digital images. Generally, the major structural differences between the CCD and CMOS image sensing devices are the amount of the incorporated A/D converters and the deployment thereof.

On the other hand, no matter it is CCD or CMOS image sensing device, there are a plurality of CCD or CMOS image sensors forming the CCD or CMOS photoelectric element array for sensing the photo energy and converting such photo energy into the electronic signals, where each image sensor is usually called a pixel element. The density and the deployment of the pixel elements in a predetermined area are the important factors influencing the image quality of the image sensing device. In general, the more pixel elements, the better quality of the generated image. Accordingly, it is a popular trend to develop a photoelectric element array with more pixel elements. With the rapid development of the semiconductor technology, it is easy to achieve a photoelectric element array with more and more pixel elements.

Nevertheless, as the density of the pixel elements in the predetermined area increase, an optical crosstalk effect might result from the excessive adjacency of the pixel elements. Please refer to FIG. 1, which schematically shows an arrangement of a conventional image sensing device. As shown in FIG. 1, the image sensing device 10 includes a first, a second and a third micro lenses 11a-11c, a first, a second and a third color filters 12a-12c, a light shielding layer 13, an IC stacking layer 14 and a first, a second and a third photo sensing elements 15a -15c. In a normal condition, a light 17a passing through the second lens 11b will be projected into the second photo sensing element 15b. Nevertheless, when the incident angle of the light become larger, as shown in FIG. 1, a light 17b with larger incident angle will pass through the second lens 11b and then be projected into the adjacent third photo sensing element 15c. Accordingly, the sensed photo signal of the third photo sensing element 15c will be affected. Such optical crosstalk effect will become serious when the density of the photo sensing elements, i.e. the pixel density in a photoelectric element array, increases.

In order to overcome such optical crosstalk effect, Yaung et al. disclosed in U.S. Pat. No. 6,803,250 a complementary concave and convex lenses structure for enhancing the optical performance of the image sensing device. Please refer to FIG. 2, which schematically shows an image sensing device with a complementary concave and convex lenses structure according to the prior art reference. As can be seen from FIG. 2, the image sensing device 20 includes a substrate 21 with a photoactive region 22 embedded therein. A first planarizing passivation layer 23 having a pair of patterned first conductor layers 24a, 24b formed therein and a second planarizing passivation layer 25 having a pair of patterned second conductor layers 26a, 26b formed therein are disposed above the substrate 21 in sequence. A color filter 28 is further disposed above the second planarizing passivation layer 25 and a first spacer layer 27 is formed therebetween. A convex lens 29 is further disposed above the color filter 28. The convex lens 29 is used for enhancing the convergence of the incident light. Furthermore, a concave structure on the spacer layer 27 is acted as a complementary element of the convex lens 29, in order that the incident light can be efficiently converged on the photoactive region 22. Nevertheless, such arrangement of the image sensing device 20 still fails to avoid the optical crosstalk effect when the chief ray angle of the incident light become large. Moreover, the concave structure of the image sensing device 20 is formed on the second planarizing passivation layer 25, which means an additional semiconductor process is necessary. Accordingly, the manufacture method of the image sensing device 20 will become costly and complicated. On the other hand, the applicant of the present application also proposed in TW patent application No. 9413609 an image sensing device with the incorporation of the micro prism for adjusting the chief ray angle of the incident light in order to avoid the optical corsstalk effect thereof. Such technical features are also proposed as the relevant technical schemes of the present invention.

On the other hand, the structural design of the package module of the image sensing device also can be an important factor to affect the optical performance thereof. Please refer to FIG. 3, which shows a conventional package module for an image sensing device. As shown in FIG. 3, the package module 30 of the image sensing device includes a substrate 31 having thereon a photoelectric element array 32, and a micro lens array 33 formed on the photoelectric element array 32 for improving the convergence of the incident light projected into the photoelectric element array 32. The photoelectric element array 32 and the micro lens array 33 is packaged between a package lid 34 and the substrate 31, and a spacer 35 is used for controlling the distance between the package lid 34 and the substrate 31. In order to avoid the incident light to be projected into the photoelectric electric array 32 with a large incident angle, the distance between the package lid 34 and the substrate 31 is usually ranged within an order of several tens micrometers, which is far beyond the dimension of each pixel element of the photoelectric element array 32. As a result, the miniaturization of such package module is always constrained by the necessary distance between the package lid 34 and the substrate 31.

Base on the above, it is clear that the conventional image sensing device not only has the problem in dealing with the optical crosstalk effect but also has the problem in miniaturizing the structure of the package module thereof. Accordingly, it is the aspect of the present application to develop a novel package module for the image sensing device and the package method therefor in order to solve the abovementioned problems.

### SUMMARY OF THE INVENTION

It is a first aspect of the present invention to provide a package module of an image sensing device. The package module of the image sensing device includes a substrate having thereon a photoelectric element array, a first optical element array formed on the photoelectric element array, a package lid having thereon a second optical element array having an arrangement corresponding to that of the first optical element array, and a spacer disposed on a bonding area between the package lid and the substrate for adjusting a distance between the package lid and the substrate.

Preferably, the first optical element array is one of a micro prism array and a micro lens array.

Preferably, the second optical element array is one of a micro prism array and a micro lens array.

Preferably, the package lid is formed by a material pervious to light.

Preferably, the package module of the image sensing device further includes at least one lens set formed on the package lid to build an optical image system of the image sensing device.

Preferably, the optical image system has a depth of focus range and the distance is within the depth of focus range.

Preferably, the photoelectric element array further includes a plurality of pixel elements, each of which has a dimension equivalent to the distance.

It is a further aspect of the present invention to provide an optical system for sensing an image. The optical system includes a package module of an image sensing device and a lens set disposed on the package module. The package module further includes a substrate having thereon a photoelectric element array, a first optical element array formed on the photoelectric element array, a package lid having thereon a second optical element array having an arrangement corresponding to that of the first optical element array, and a spacer disposed on a bonding area between the package lid and the substrate for controlling a distance between the first and second optical element arrays. The lens set disposed on the package lid transforms a light incident to the optical system into the image.

Preferably, the first optical element array is one of a micro prism array and a micro lens array.

Preferably, the second optical element array is one of a micro prism array and a micro lens array.

Preferably, the package lid is formed by a material pervious to light.

Preferably, the optical system further has a depth of focus range and the distance is within the depth of focus range.

Preferably, the photoelectric element array further includes a plurality of pixel elements, each of which has a dimension equivalent to the distance.

It is a further aspect of the present invention to provide a method for packaging an image sensing device. The method includes the steps of providing a substrate and a package lid, forming a photoelectric element array on the substrate, forming a first optical element array on the photoelectric element array, forming a second optical element array on the package lid, and bonding the package lid and the substrate in such a way that the first optical element array has an arrangement corresponding to that of the second optical element array.

Preferably, the second optical element array formed on the package lid is manufactured by a semiconductor process.

Preferably, the step of bonding the package lid and the substrate further includes a step of forming a spacer therebetween in order to control a distance between the package lid and the substrate.

Preferably, the photoelectric element array further includes a plurality of pixel elements, each of which has a dimension equivalent to the distance.

Preferably, the method further includes a step of forming a lens set on the package lid for constructing an optical image system of the image sensing device.

Preferably, the optical image system has a depth of focus range, and the distance is within the depth of focus range.

### BRIEF DESCRIPTION OF THE DRAWINGS

The above objects and advantages of the present invention will become more readily apparent to those ordinarily skilled in the art after reviewing the following detailed descriptions and accompanying drawings, in which:

FIG. 1 schematically shows an arrangement of a conventional image sensing device;

FIG. 2 schematically shows an image sensing device with a complementary concave and convex lenses structure according to the prior art;

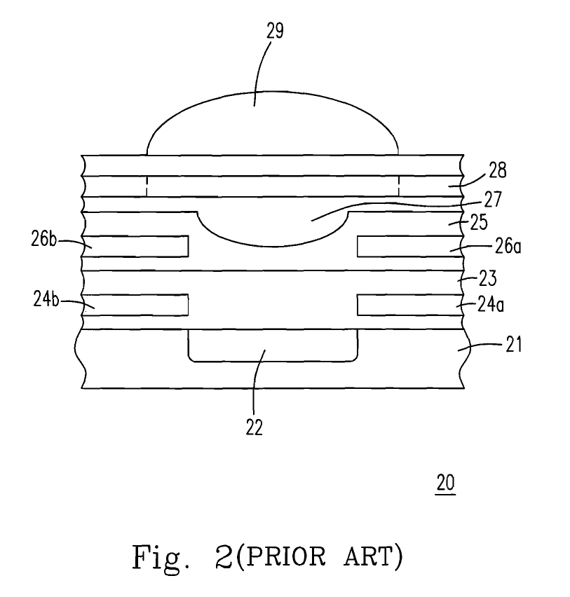

FIG. 3 schematically shows a conventional package module for an image sensing device;

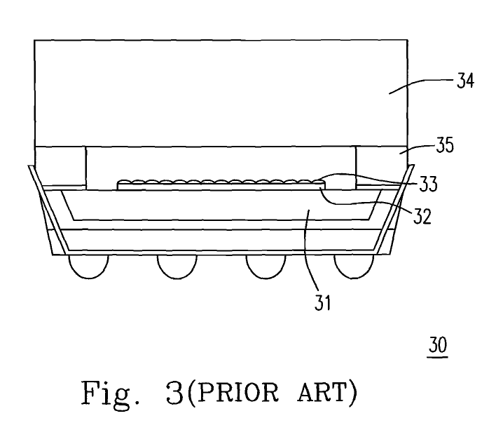

FIGS. 4(A) and 4(B) schematically show a concept of the present invention to incorporate a further micro prism into an image sensing device for improving the convergence of an incident light with lager chief ray angle;

FIGS. 5(A) and 5(B) schematically show a further concept of the present invention to incorporate a further micro lens into an image sensing device for improving the convergence of an incident light with lager chief ray angle;

FIG. 6(A) schematically shows a package module for an image sensing device according to a first embodiment of the present invention;

FIG. 6(B) schematically shows an alternative embodiment of the package module according to FIG. 6(A);

FIG. 7(A) schematically shows a package module for an image sensing device according to a second embodiment of the present invention;

FIG. 7(B) schematically shows an alternative embodiment of the package module according to FIG. 7(A);

FIG. 8(A) schematically shows a package module for an image sensing device according to a third embodiment of the present invention;

FIG. 8(B) schematically shows an alternative embodiment of the package module according to FIG. 8(A); and

FIG. 9 schematically shows an optical system for sensing an image according to a fourth embodiment of the present invention.

### DETAILED DESCRIPTION OF THE PREFERRED EMBODIMENT

The present invention will now be described more specifically with reference to the following embodiments. It should to be noted that the following descriptions of preferred embodiments of this invention are presented herein for purposes of illustration and description only; it is not intended to be exhaustive or to be limited to the precise form disclosed.

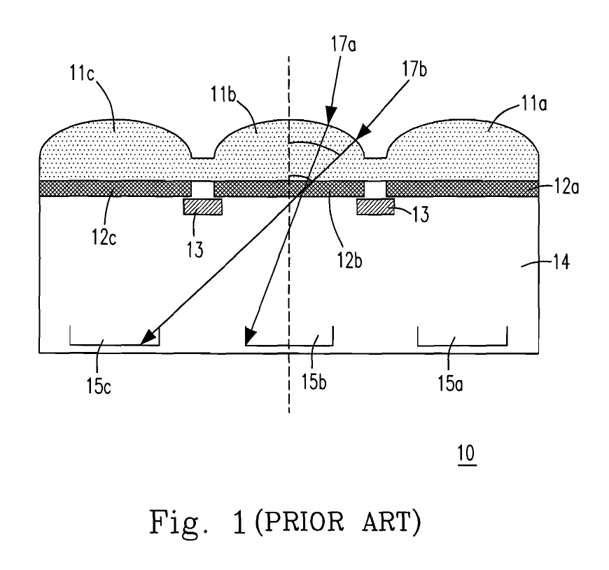

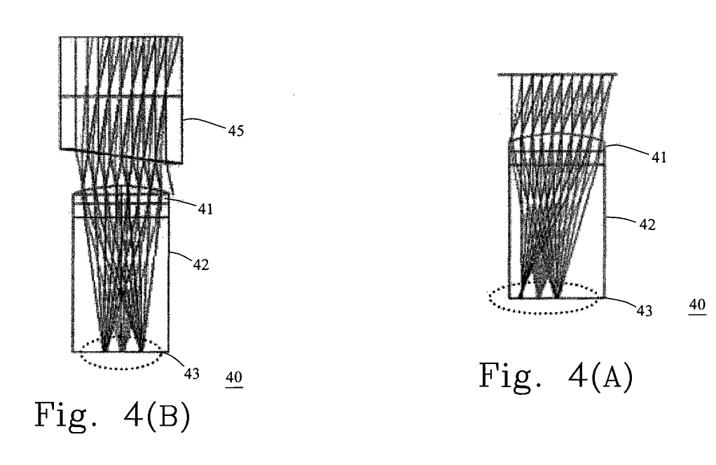

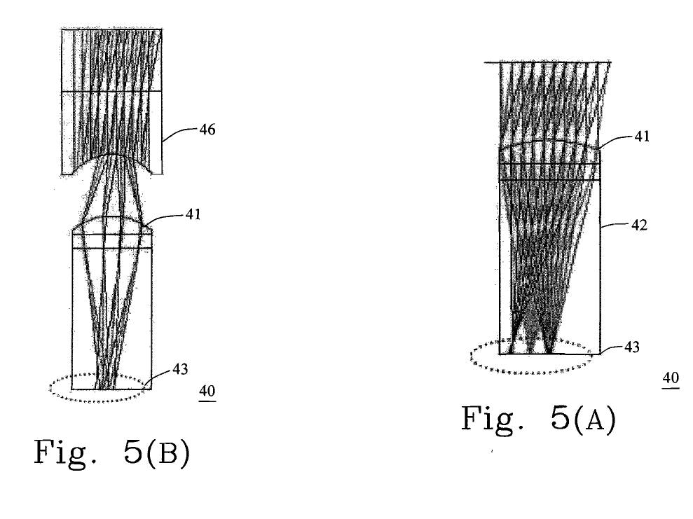

Please refer to FIGS. 4(A) and 4(B), which schematically show an incorporation of a micro prism into an image sensing device for improving the convergence of the light with lager chief ray angle in order to avoid the possible optical crosstalk effect resulting therefrom. As shown in FIG. 4(A), a single pixel structure 40 of an image sensing device is provided. Similar to the structural features mentioned in FIG. 1, The pixel structure 40 from the top to bottom includes a micro lens 41, an IC stacking layer 42 and a photo sensing element 43. Although it is clear that the micro lens disposed on the top side of the pixel structure 40 has a function on enhancing the convergence of the incident light, it is also clear that such convergence effect will be decreased as the chief ray angle of the incident light increases. Accordingly, in such pixel structure with only one micro lens disposed thereon, the optical crosstalk effect cannot be fully overcome. Nevertheless, if a further micro optical element 45, such as the micro prism, is incorporated into the pixel structure 40, as shown in FIG. 4(B), the chief ray angle of the incident light can be adjusted to a smaller one before passing through the micro lens 41, and thus the optical crosstalk effect of the image sensing device can be easily overcome. Furthermore, FIGS. 5(A) and 5(B) also schematically show a further concept of the present invention to incorporate a micro lens into an image sensing device for improving the convergence of the incident light with lager chief ray angle. As can be seen from FIG. 5(B), the only difference between the pixel structure in FIG. 4(B) and that in FIG. 5(B) is the micro prism 45 in FIG. 4(B) being replaced by a further micro lens 46. Specifically, it is the feature of the present invention to use an optical element for adjusting the chief ray angle of the incident light and a further optical element for enhancing the convergence of the incident light projected into the photo sensing element. Nevertheless, it is clear to one skilled in this art that the two sets of optical elements can be selected from a group consisting of a micro convex lens, a micro concave lens and a micro prism and the like without being constrained by the abovementioned embodiments.

In addition to the technical schemes used for overcoming the optical crosstalk effect of the image sensing device, it is also important to propose a novel package scheme to incorporate such optical elements into the image sensing device. Accordingly, a novel package module and a package method thereof are provided as follows.

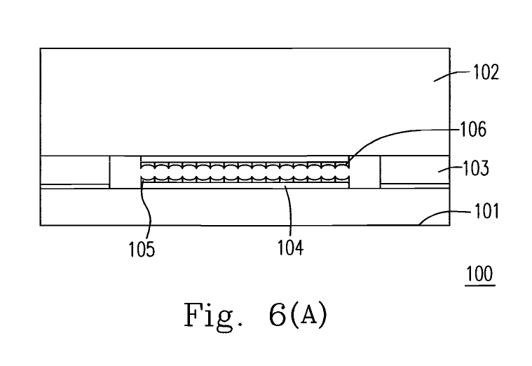

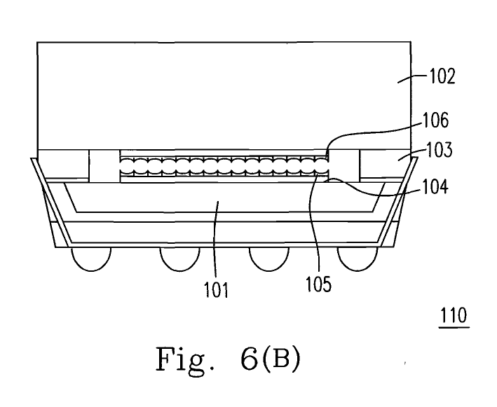

Please refer to FIG. 6(A) which schematically shows a package module for an image sensing device according to a first embodiment of the present invention. As can be seen from FIG. 6(A), the package module 100 of the image sensing device mainly includes a substrate 101 and a package lid 102. A spacer 103 is disposed between the substrate 101 and the package lid 102 for adjusting a distance between the substrate 101 and the package lid 102. The substrate 101 further has a photoelectric element array 104 formed thereon. Typically, the photoelectric element array 104 is composed of a plurality of pixel elements, which might be one of the CCD image sensors and the CMOS image sensors. Furthermore, a first optical element array 105 including a plurality of micro concave lenses is formed on the photoelectric element array 104, where each of the plurality of micro concave lenses is corresponding to each pixel elements of the photoelectric element array 104 for enhancing the convergence of the light incident to each pixel elements. On the other hand, the package lid 102 is usually made of the material pervious to light and has a second optical element array 106 formed thereon. The second optical element array 106 is also composed by a plurality of micro concave lenses and the second optical element array 106 is disposed opposite to the first optical element array 105 in such a way that each of the plurality of micro concave lenses of the first optical element array 105 has an arrangement corresponding to that of the second optical element array 106. The second optical element array 106 is used for adjusting the chief ray angle of the light incident into the image sensing device, in order to avoid the optical crosstalk problem thereof.

Please further refer to FIG. 6(B), which schematically shows an alternative embodiment of the package module according to FIG. 6(A). As shown in FIG. 6(B), the package module 110 also includes a substrate 101 having a photoelectric element array 104 formed thereon, a package lid 102, a spacer 103, a first optical element array 105 formed on the photoelectric element array 104 and a second optical element array 106 formed on the package lid 102 and disposed opposite to the first optical element array 105, as those illustrated in the FIG. 6(A). The only difference between the package module 100 in FIG. 6(A) and the package module 110 in FIG. 6(B) is the photoelectric element array 104 in the package module 110 of the image sensing device being formed on the wafer level substrate 101. Accordingly, the package module 110 of the image sensing device is packaged with the wafer level chip scale package (Wafer level CSP) technology, in order to miniaturize the package size of the image sensing device.

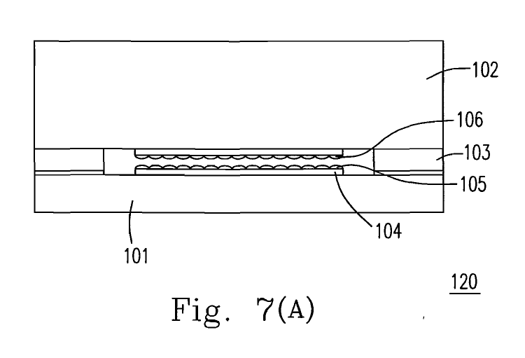

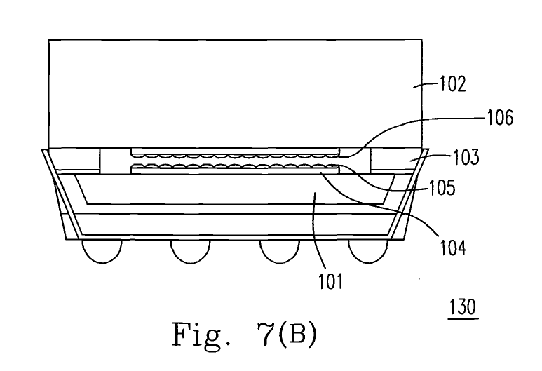

Please refer to FIG. 7(A), which schematically shows a package module for an image sensing device according to a second embodiment of the present invention. Comparing the package module 120 of the image sensing device in FIG. 7(A) with the abovementioned package module 100 in FIG. 6(A), the structural difference existing therebetween is that both the first and the second optical element arrays 105 and 106 in FIG. 7(A) are replaced by the micro convex lens arrays. Furthermore, similar to the image sensing device 110 in FIG. 6(B), the image sensing device 130 in FIG. 7(B) is also packaged by a wafer level CSP technology, in order to miniaturize the package size of the image sensing device.

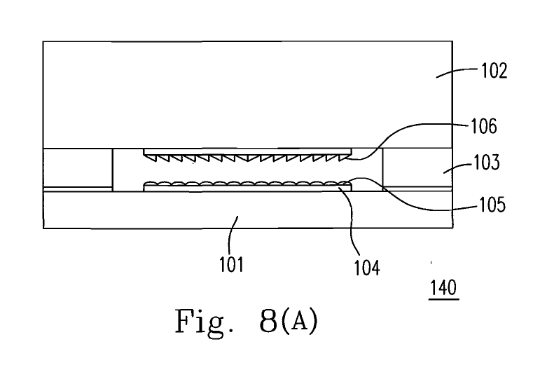

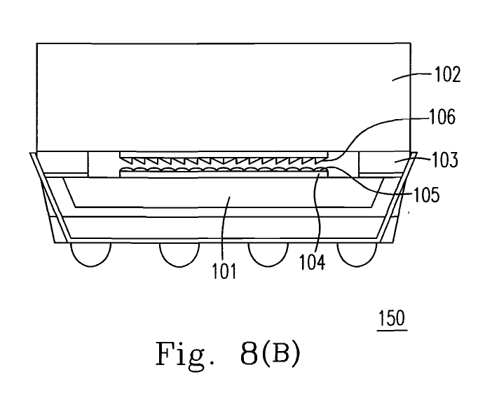

Similarly, the package modules 140 and 150 of the image sensing devices in the respective FIGS. 8(A) and 8(B) are the package module according to a third embodiment of the present invention and an alternative embodiment thereof. The only structural differences existing between the package module 140 in FIG. 8(A) and the abovementioned package modules 100 and 120 in the respective FIGS. 6(A) and 7(A) are that the first optical element array 105 is formed by a micro lens array and the second optical element array 106 is formed by a micro prism array. Moreover, the package module 150 in FIG. 8(B) is also shown to be packaged through the wafer level CSP technology, in order to miniaturize the package size of the image sensing device.

From the first to the third embodiments of the present invention and the alternative embodiments thereof, it is clear that the first and the second optical elements can be arbitrarily selected from a group consisting of a micro convex lens, a micro concave lens and a micro prism and the like. Furthermore, as mentioned above, since each of the first optical element array 105 has an arrangement corresponding to that of the second optical element array 106, the distance between the package lid 102 and the substrate 101 can be designed to be equivalent to the dimension of each pixel element of the image sensing device. Besides, the distance between the package lid 102 and the substrate 101 can also be controlled within a depth of focus range of an optical image system of the image sensing device. As a result, the distance between the package lid 102 and the substrate 101 can be reduced from an order of several tens micrometers to an order of several micrometers.

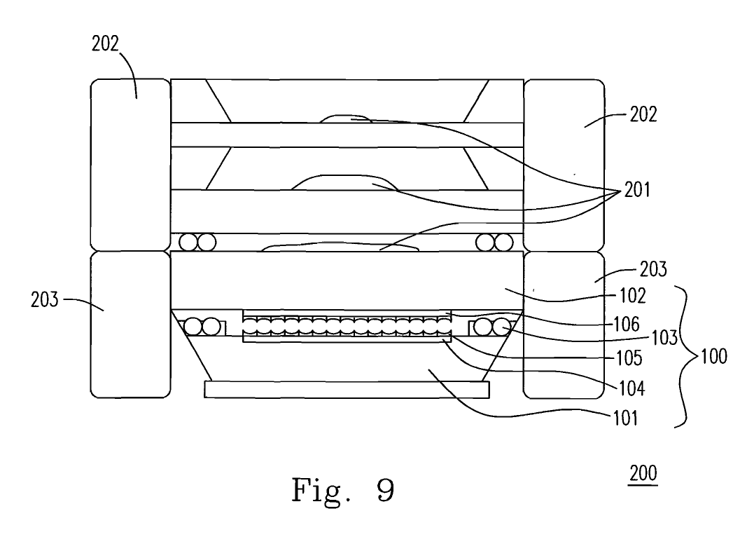

Please further refer to FIG. 9, which schematically shows an optical system for sensing an image. As shown in FIG. 9, the optical system 200 includes the abovementioned package module 100 and lens set 201 disposed on the package module for transforming a light incident to the optical system into the image. As mentioned above, the package module 100 includes a substrate 101 having thereon a photoelectric element array 104 and a first photo element array 105 formed in sequence and a package lid 102 having thereon a second optical element array 106. A spacer 103 is disposed between the substrate 101 and the package lid 102 for controlling a distance between the first and the second optical element arrays. Similarly, the first optical element array 105 is disposed opposite to the second optical element array 106 and each of the first optical element array 105 has an arrangement corresponding to that of the second optical element array 106. Furthermore, the lens set 201 is disposed on the package lid in order to transform a light incident to the optical system into the image projected to package module 100. The lens set 201 of the optical system 200 further has a depth of focus range and the distance between the first and the second optical element arrays can be controlled by the spacer to be ranged within the depth of focus range in order to miniaturize the volume of the optical system.

Furthermore, in a preferred embodiment of the present invention, the optical system 200 further includes a light shielding material 202 disposed around the lens set 201 in order to avoid the optical interference occurring in the lens set 201. Moreover, a further electromagnetic interference (EMI) protection material 203 may also be disposed around the package module 100 for preventing the package module 100 from being interfered by the electromagnetic interference.

It also should be noted that a method for packaging an image sensing device or an optical system for sensing an image according to the present invention is also provided. Nevertheless, such packaging method are totally compatible with the conventional semiconductor process, the integrated optical process, and the package process for the semiconductor device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A package module for an image sensing device, comprising:
a substrate having thereon a photoelectric element array;
a first optical element array formed on the photoelectric element array;
a package lid having thereon a second optical element array opposite to the first optical element array and having an arrangement corresponding to that of the first optical element array; and
a spacer disposed on a bonding area between the package lid and the substrate for adjusting a distance between the package lid and the substrate.

2. A package module according to claim 1, wherein the first optical element array is one of a micro prism array and a micro lens array.

3. A package module according to claim 1, wherein the second optical element array is one of a micro prism array and a micro lens array.

4. A package module according to claim 1, wherein the package lid is formed by a material pervious to light.

5. A package module according to claim 1, further comprising at least one lens set formed on the package lid to build an optical image system of the image sensing device.

6. A package module according to claim 5, wherein the optical image system has a depth of focus range and the distance is within the depth of focus range.

7. A package module according to claim 1, wherein the photoelectric element array further comprises a plurality of pixel elements, each of which has a dimension equivalent to the distance.

8. An optical system for sensing an image, comprising:
a package module for an image sensing device, comprising:
a substrate having thereon a photoelectric element array;
a first optical element array formed on the photoelectric element array;
a package lid having thereon a second optical element array having an arrangement corresponding to that of the first optical element array; and
a spacer disposed on a bonding area between the package lid and the substrate for controlling a distance between the first and second optical element arrays; and
a lens set disposed on the package lid and transforming a light incident to the optical system into the image.

9. An optical system according to claim 8, wherein the first optical element array is one of a micro prism array and a micro lens array.

10. An optical system according to claim 8, wherein the second optical element array is one of a micro prism array and a micro lens array.

11. An optical system according to claim 8, wherein the package lid is formed by a material pervious to light.

12. An optical system according to claim 8, further having a depth of focus range and the distance is within the depth of focus range.

13. An optical system according to claim 8, wherein the photoelectric element array further comprises a plurality of pixel elements, each of which has a dimension equivalent to the distance.

14. A method for packaging an image sensing device, comprising the steps of:
providing a substrate and a package lid;
forming a photoelectric element array on the substrate;
forming a first optical element array on the photoelectric element array;
forming a second optical element array on the package lid; and
bonding the package lid and the substrate in such a way that the first optical element array has an arrangement corresponding to that of the second optical element array.

15. A method according to claim 14, wherein the second optical element array formed on the package lid is manufactured by a semiconductor process.

16. A method according to claim 14, wherein the step of bonding the package lid and the substrate further comprises a step of forming a spacer therebetween in order to control a distance between the package lid and the substrate.

17. A method according to claim 16, wherein the photoelectric element array further comprises a plurality of pixel elements, each of which has a dimension equivalent to the distance.

18. A method according to claim 14, further comprising a step of forming a lens set on the package lid for constructing an optical image system of the image sensing device.

19. A method according to claim 14, wherein the optical image system has a depth of focus range, and the distance is within the depth of focus range.
